(19) United States
(12) Patent Application Publication
(10) Pub. No.: US 2025/0200624 A1
(43) Pub. Date: Jun. 19, 2025

(54) METHOD AND SYSTEM FOR IDENTIFYING A MATCH WITH A PRODUCT

(71) Applicant: GRABTAXI HOLDINGS PTE. LTD., Singapore (SG)

(72) Inventors: Jia DU, Singapore (SG); Wai Teng TANG, Singapore (SG)

(21) Appl. No.: 18/844,452

(22) PCT Filed: Apr. 10, 2023
(86) PCT No.: PCT/SG2023/050241

§ 371 Date: Sep. 6, 2024

(30) Foreign Application Priority Data
May 4, 2022 (SG) 10202204666R

(51) Int. Cl. G06Q 30/0601; G06V 20/60

(52) U.S. Cl. CPC G06Q 30/0625; G06V 20/60

(57) ABSTRACT

The present disclosure provides methods and systems for identifying a match with a product. In some examples, there is provided a method for identifying a match with a product, comprising: extracting, by a processor, one or more attributes relating to a product from data indicated in a request for identifying the product, each of the one or more attributes describing the product; adapting, by the processor, the one or more attributes based on historical data relating to the product into a same format as that of one or more entries in a database, the database comprising one or more entries for each of a plurality of products; and identifying a match with the product from the plurality of products, the identification based on comparing, by the processor, the one or more attributes with each corresponding entry of the plurality of products.

### FIELD OF INVENTION

The present disclosure relates broadly, but not exclusively, to methods and systems for identifying a match with a product.

### BACKGROUND

Currently on platforms offering various products for sale, the products listed are typically each identified with an item ID that is unique to a merchant or the platform offering the product, but they are not identifiable with a common identifier such as, for example, a Product Stock Keeping Unit (SKU) number which can cut across merchants and stores. As a result, this hampers a platform's ability to partner with fast moving consumer goods (FMCG) companies to enable them to advertise on the platform.

In an ideal situation, merchants will add a Global Trade Item Number (GTIN) to their product items while onboarding and categorising FMCG products into their menus. However, in reality, most merchants do not add the GTIN as it is time consuming with no direct benefit to them. As a result, since FMCGs are not able to track product availability and sales performance due to this gap, they have no means to drive demand for merchants by discounting specific products across merchants, evaluating campaign Return on Investment/Return on Ad Spend (ROI/ROAS), and justifying further investment. Further, manually adding GTINs for all FMCGs in a platform would require an extremely and unfeasible time to complete. Thus, it is necessary to develop a system to help add GTIN to as many FMCG brand product items as possible to enable GTIN-level tracking.

A need therefore exists to provide methods and systems that seek to overcome or at least minimize the above mentioned challenges.

### SUMMARY

According to a first aspect of the present disclosure, there is provided a method for identifying a match with a product, comprising: extracting, by a processor, one or more attributes relating to a product from data indicated in a request for identifying the product, each of the one or more attributes describing the product, wherein the data comprises an image of the product and extracting the one or more attributes comprises identifying the one or more attributes from the image based on a visual question and answering (VQA) paradigm; adapting, by the processor, the one or more attributes based on historical data relating to the product into a same format as that of one or more entries in a database, the database comprising one or more entries for each of a plurality of products; and identifying a match with the product from the plurality of products, the identification based on comparing, by the processor, the one or more attributes with each corresponding entry of the plurality of products; selecting one or more products from the plurality of products in the database based on a rule-based comparison of at least one of the one or more attributes with each corresponding entry in the database; identifying the match with the product from the selected one or more products, the identification based on comparing, by the processor, the one or more attributes with each corresponding entry of the selected one or more products; calculating a score for each of the selected one or more products based on the comparison; identifying the match with the product when the score for the match is a highest score of the calculated scores and greater than a threshold value; verifying whether each of the selected one or more products excluding the identified match having a score greater than the threshold value is also a match with the product; and retraining the processor based on the verification.

According to a second aspect of the present disclosure, there is provided a system for identifying a match with a product, comprising: at least one processor; and at least one memory including computer program code; the at least one memory and the computer program code configured to, with the at least one processor, cause the system at least to: extract, by a processor, one or more attributes relating to a product from data indicated in a request for identifying the product, each of the one or more attributes describing the product, wherein the data comprises an image of the product and extracting the one or more attributes comprises identifying the one or more attributes from the image based on a visual question and answering (VQA) paradigm; adapt, by the processor, the one or more attributes based on historical data relating to the product into a same format as that of one or more entries in a database, the database comprising one or more entries for each of a plurality of products; and identify a match with the product from the plurality of products, the identification based on comparing, by the processor, the one or more attributes with each corresponding entry of the plurality of products; select one or more products from the plurality of products in the database based on a rule-based comparison of at least one of the one or more attributes with each corresponding entry in the database; identify the match with the product from the selected one or more products, the identification based on comparing, by the processor, the one or more attributes with each corresponding entry of the selected one or more products; calculate a score for each of the selected one or more products based on the comparison; identify the match with the product when the score for the match is a highest score of the calculated scores and greater than a threshold value; verify whether each of the selected one or more products excluding the identified match having a score greater than the threshold value is also a match with the product; and retrain the processor based on the verification.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for identifying a match with a product according to various embodiments of the present disclosure.

FIG. 2 is a schematic diagram of a product matching server, according to various embodiments of the present disclosure.

FIG. 3 is an overview of a process for identifying a match with a product, according to various embodiments.

FIG. 4 depicts an example illustration of a visual question and answering (VQA) process according to various embodiments.

FIG. 5 illustrates an example framework for identifying a match with a product according to various embodiments.

FIG. 6 illustrates an example illustration of mapping a product with a GTIN reference list according to various embodiments.

FIG. 7 illustrates an example flow diagram of a method for identifying a match with a product according to various embodiments.

FIGS. 8A and 8B form a schematic block diagram of a general purpose computer system upon which the transaction processing server of FIG. 1 can be practiced.

FIG. 8C is a schematic block diagram of a general purpose computer system upon which the product matching server of FIG. 2 can be practiced.

FIG. 8D is a schematic block diagram of a general purpose computer system upon which a combined transaction processing and product matching server of FIG. 1 can be practiced.

FIG. 9 shows an example of a computing device to realize the transaction processing server shown in FIG. 1.

FIG. 10 shows an example of a computing device to realize the product matching server shown in FIG. 1.

FIG. 11 shows an example of a computing device to realize a combined transaction processing and product matching server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a de-sired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “extracting”, “adapting”, “identifying”, “selecting”, “calculating”, “verifying”, “retraining”, “indicating”, “mapping”, “comparing”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

A platform refers to a business model that creates value by facilitating exchanges between two or more interdependent groups, for example between a requestor (of a product or service) and a provider (of the product or service). For example, a platform may offer a service offered by a provider such as a ride, delivery, online shopping, insurance, and other similar services to a requestor. The requestor can typically access the platform via a website, an application, or other similar methods.

A Global Trade Item Number (GTIN) is a globally unique identifier and is defined to identify trade items as products or services that are priced, ordered or invoiced at any point in the supply chain. It is widely used in fast moving consumer goods (FMCG) industries (e.g. Coca-Cola™) to uniquely identify all of its trade items. In order to expand a platform's partnership growth with FMCGs, a system for GTIN-level tracking of products across the platform is essential for most FMCG business use cases, such as participation in advertising campaigns, market sampling, onboarding for services offered by the platform such as delivery (of the concerned products), and performance reporting for product sales. The GTINs may be compiled in a database, for example in a form of a list or other similar format comprising one or more GTINs, each GTIN corresponding to a different product, with each GTIN further including one or more entries relating to the respective corresponding product. Each of the one or more entries may be an attribute that describe the respective corresponding product, such as a brand, colour, size, volume, flavour, quantity, or other similar feature that describe or define the product. The database may then be used for reference for identifying a match with a product, and the GTIN that corresponds to the match may be mapped to the concerned product. It will be appreciated that the products referred to herein need not be limited to FMCGs, and may generally refer to any item that can be provided by a provider for sale to a requestor.

An attribute of a product refers to a product feature that may be used to differentiate one product from another. For example, an attribute of a product may be a brand, colour, size, volume, flavour, quantity, or other similar feature that describe or define the product. Such attributes of a product may be extracted from information relating to the product (e.g. textual information and image information) and utilized to identify a match with the product. Such an extraction of attributes involving different modes of information in the form of text and images may be termed as a multimodal attribute extraction. This is particularly useful when the information relating to the product is unstructured and multimodal (e.g. compressing both text and images). Common forms of textual information may include product names, descriptions, nutritional information, and other similar metadata. The extracted attribute may further be adapted into a suitable format for further analysis, such as for comparison with the database comprising one or more GTINs as described above. The adaption into a suitable format may be based on historical data relating to the concerned product. For example, domain knowledge injection may be utilized to bridge the gap between the extracted attributes and the one or more entries in the GTIN database, wherein historical data relating to the product (such as domain knowledge relating to the product) are leveraged to enrich the extracted attributes. Domain knowledge may comprise product attribute synonyms in various languages, unit system, or other similar formats. Historical data may also comprise labelled and unlabelled data relating to the product. Labelled data refers to any data relating to the product that has been annotated with certain properties or attributes or characteristics that is useful for supervised training of a machine learning model, including a neural network model, in order to make accurate predictions. On the other hand, unlabelled data refers to such raw data relating to the product that has not been labelled or annotated with additional properties. Accordingly, the major processes for adapting an extracted attribute into a suitable format (e.g. adapting into a same format as that of the one or more entries in the database) may include language conversion, unit conversion, quantity and synonym normalization, and other similar, so that the extracted attribute can be reliably and accurately compared to each corresponding entry in the database.

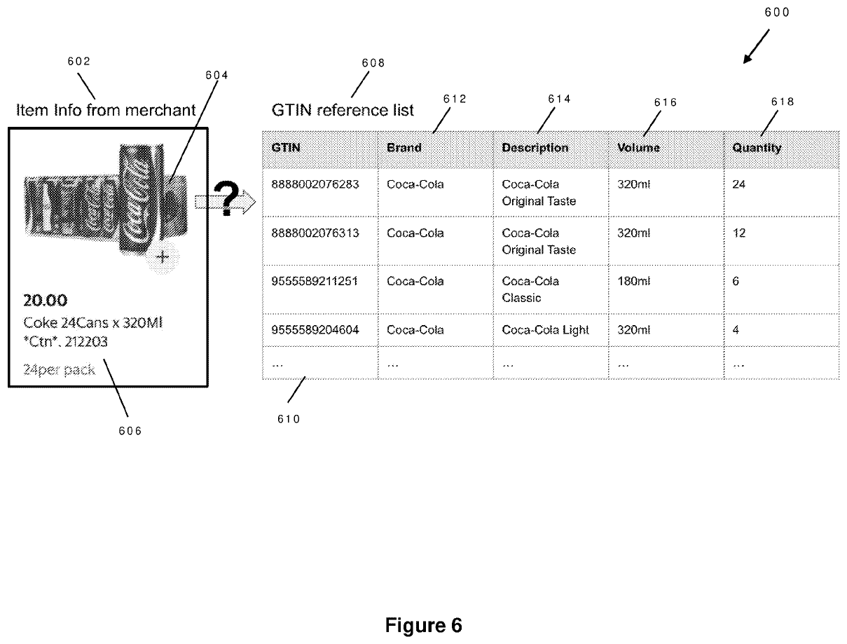

An objective to be discussed in the present disclosure is to identify a GTIN for a product based on information relating to the product (for example received from merchants for onboarding of the product on the platform, so that the product can be viewed and bought by users of the platform) and a GTIN reference database. As shown in illustration 600 of FIG. 6, item information 602 generally includes image information 604 as well as textual information 606 (for example comprising item name, description, quantity, volume, weight, and other similar information), and other metadata depending on the merchant's inputs. Attributes of the concerned item that are extracted from item information 602 may be compared with a GTIN reference list 608. The GTIN reference list 608 may be updated based on information from entities such as GS1™ and other verified sources such as FMCGs. Besides GTIN number 610, each row of the GTIN reference list 608 also includes entries of product information such as brand 612, description 614, volume 616 and quantity 618. It will be appreciated that the entries may further comprise other specifications or attributes that describe the item or product.

There are several challenges in identifying a match with a product and deciding whether an item should be mapped to a certain GTIN in the GTIN reference list 608. Product attributes such as brand, colour, size, volume, flavour, quantity, or other similar feature that describe or define the product are features that can be used to differentiate one product from another. However, an attribute-based matching is not easy, because information related to the product is typically provided in unstructured and multimodal form from, for example, merchants looking to on-board the product to the platform. Merchants often put all the item information in a single string of item name with free style writing (e.g., “Coke™ No Sugar 12×320 ml”). In other cases, some attributes such as volume, flavour or type of containers are missing from item names and can only be found from images that are up-loaded as part of the data related to the product. Even after the extraction of attributes, there may exist knowledge gaps between the extracted attributes from the data and the GTIN reference list 608. Since a platform can typically operate in many different countries, merchants are likely to use a variety of languages while the GTIN reference list 608 may generally be in English. To make things more complex and confusing, merchants also like to use synonyms for brands or products such as “Coke™” for Coca-cola™. In addition, the unit of measurement may also be different between merchants and the GTIN reference list 608. For example, some local merchants tend to use “fl.oz” instead of “ml” for volume, and “lbs” instead of “kg” for weight.

Item to GTIN matching by its nature is a dynamic process with human assistance and facilitation in loop. New products come into the market every day with new brands and with their unique attributes. GTIN reference list 608 needs to be kept updated with new GTINs, while matching rules also have to adapt to the new types of attributes. Further, the matching system also needs to learn from feedback and empirical rules provided and set by, for example, content operations of the concerned platform. Content operations refer to a set of processes, people, and technologies needed for strategically planning, creating, managing, and analyzing all content types for all channels across an enterprise such as a platform. For example, although there are a large number of products that may just use ‘Coke™’ as titles without additional information, content operations may facilitate the process by assigning such titles to a default GTIN for “Coca-Cola™ Original 320 ml” for better mapping coverage in practice.

A user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing or product matching server will be called a registered user. A user who is not registered to the transaction processing server or product matching server will be called a non-registered user. The term user will be used to collectively refer to both registered and non-registered users. A user may interchangeably be referred to as a requestor (e.g. a person who requests for a product or service) or a provider (e.g. a person who provides the requested product or service to the requestor).

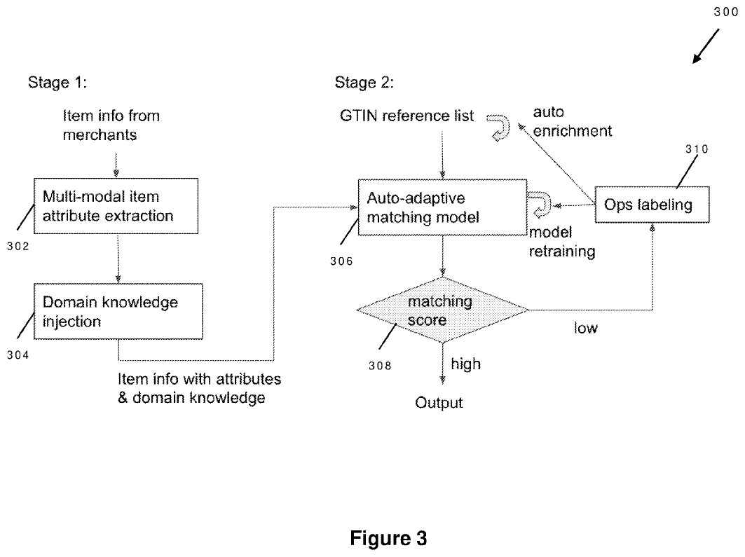

A product matching server is a server that hosts software application programs for performing product matching. The product matching server may be implemented as shown in schematic diagram 300 of FIG. 3 for identifying match with a product.

The transaction processing server is a server that hosts software application programs for processing payment transactions for, for example, purchasing of a good or service by a user. The transaction processing server communicates with any other servers (e.g., a product matching server) concerning processing payment transactions relating to the purchasing of the good or service. For example, in a case where product matching is a service provided by the platform, the transaction processing server may communicate with the product matching server to facilitate payment for the product matching service after a match for a product (e.g. matching based on product information provided by the user requesting the product matching) has been identified, and/or after a corresponding GTIN has been provided for the identified product to the user requesting the product matching. In another example, in a case where product matching is part of an on-boarding procedure for a product, the transaction processing server may or may not be required to communicate with the product matching server to facilitate the on-boarding process. The transaction processing server may use a variety of different protocols and procedures in order to process the payment and/or travel co-ordination requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

The transaction processing server is usually managed by a service provider that may be an entity (e.g. a company or organization) which operates to process transaction requests and/or travel co-ordination requests e.g. pair a provider of a travel co-ordination request to a requestor of the travel co-ordination request. The transaction processing server may include one or more computing devices that are used for processing transaction requests and/or travel co-ordination requests.

A transaction account is an account of a user who is registered at a transaction processing server. The user can be a customer, a merchant providing a product for sale on a platform and/or for onboarding the platform, a hail provider (e.g., a driver), or any third parties (e.g., a courier) who want to use the transaction processing server. In certain circumstances, the transaction account is not required to use the face recognition server. A transaction account includes details (e.g., name, address, vehicle, face image, etc.) of a user. The transaction processing server manages the transaction accounts of users and the interactions between users and other external servers.

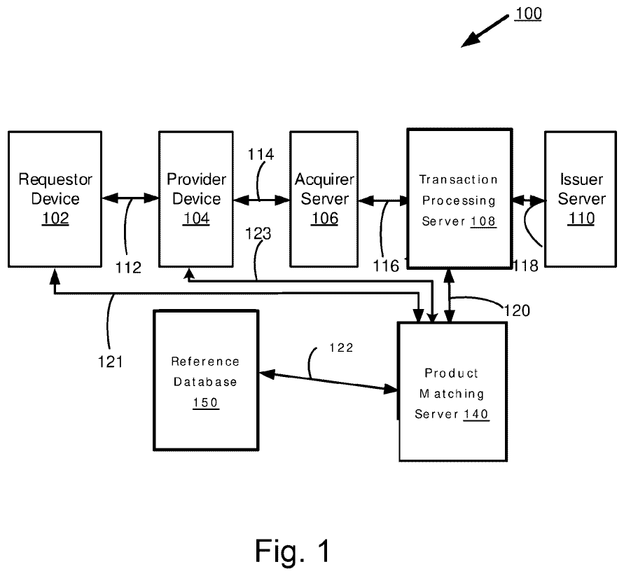

FIG. 1 illustrates a block diagram of a system 100 for identifying a match with a product. Further, the system 100 enables a payment transaction for a good or service, and/or a request for a ride between a requestor and a provider.

The system 100 comprises a requestor device 102, a provider device 104, an acquirer server 106, a transaction processing server 108, an issuer server 110, a product matching server 140 and a reference database 150.

The requestor device 102 is in communication with a provider device 104 via a connection 112. The connection 112 may be wireless (e.g., via NFC communication, Bluetooth, etc.) or over a network (e.g., the Internet). The requestor device 102 is also in communication with the product matching server 140 via a connection 121. The connection 121 may be via a network (e.g., the Internet). The requestor device 102 may also be connected to a cloud that facilitates the system 100 for identifying a match with a product. For example, the requestor device 102 can send a signal or data to the cloud directly via a wireless connection (e.g., via NFC communication, Bluetooth, etc.) or over a network (e.g., the Internet).

The provider device 104 is in communication with the requestor device 102 as described above, usually via the transaction processing server 108. The provider device 104 is, in turn, in communication with an acquirer server 106 via a connection 114. The provider device 104 is also in communication with the product matching server 140 via a connection 123. The connections 114 and 123 may be via a network (e.g., the Internet). The provider device 104 may also be connected to a cloud that facilitates the system 100 for identifying a match with a product. For example, the provider device 104 can send a signal or data to the cloud directly via a wireless connection (e.g., via NFC communication, Bluetooth, etc.) or over a network (e.g., the Internet).

The acquirer server 106, in turn, is in communication with the transaction processing server 108 via a connection 116. The transaction processing server 108, in turn, is in communication with an issuer server 110 via a connection 118. The connections 116 and 118 may be a network (e.g., the Internet).

The transaction processing server 108 is further in communication with the product matching 140 via a connection 120. The connection 120 may be over a network (e.g., a local area network, a wide area network, the Internet, etc.). In one arrangement, the transaction processing server 108 and the product matching server 140 are combined and the connection 120 may be an interconnected bus.

The product matching server 140, in turn, is in communication with the reference database 150 via respective connection 122. The connection 122 may be a network (e.g., the Internet). The product matching server 140 may also be connected to a cloud that facilitates the system 100 for identifying a match with a product. For example, the product matching server 140 can send a signal or data to the cloud directly via a wireless connection (e.g., via NFC communication, Bluetooth, etc.) or over a network (e.g., the Internet).

The reference database 150 comprises a compilation of entries for a plurality of products, wherein each product includes one or more entries describing the associated product. The reference database 150 may be combined with the product matching server 140. In an example, the reference database 150 may be a database managed by an external entity and the product matching server 140 is a server that, based on data relating to a product indicated in a request for identifying the product (e.g. the request being provided by a user or provided during an onboarding process for a product), extracts one or more attributes relating to the product, each of the one or more attributes describing the product. The product matching server 140 may then adapt the one or more attributes based on historical data relating to the product into a same format as that of one or more entries in the reference database 150, the reference database 150 comprising one or more entries for each of the plurality of products. Further, the product matching server 140 may then identify a match with the product from the plurality of products, the identification based on comparing the one or more attributes with each corresponding entry of the plurality of products.

Alternatively, a module may store the compilation of information for the plurality of products instead of the reference database 150, wherein the module may be integrated as part of the product matching server 140 or external from the product matching server 140.

In the illustrative embodiment, each of the devices 102, 104, and the servers 106, 108, 110, 140, and 150 provides an interface to enable communication with other connected devices 102, 104 and/or servers 106, 108, 110, 140, and 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for at least one of the requestor device 102 and the provider device 104 to send data relating to a product in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The product matching server 140 is associated with an entity (e.g. a company or organization or moderator of the service). In one arrangement, the product matching server 140 is owned and operated by the entity operating the transaction processing server 108. In such an arrangement, the product matching server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the product matching server 140. The user may be a requestor or a provider associated with the requestor device 102 or the provider device 104, respectively.

Details of the registration include, for example, name of the user, address of the user, emergency contact, blood type or other healthcare information, next-of-kin contact, permissions to retrieve data and information from the requestor device 102 and/or the provider device 104 for product identification purposes, such as permission to use a cam-era of the requestor device 102 and/or the provider device 104 to take a picture of a product, wherein the picture may be used by the product matching server 140 as data for product identification purposes. Alternatively, another mobile device may be selected instead of the requestor device 102 and/or the provider device 104 for retrieving the data. Once on-boarded, the user would have a transaction account that stores all the details.

The requestor device 102 is associated with a customer (or requestor) who is a party to a transaction that occurs between the requestor device 102 and the provider device 104, or between the requestor device 102 and the product matching server 140. The requestor device 102 may be a computing device such as a desktop computer, an interactive voice response (IVR) system, a smartphone, a laptop computer, a personal digital assistant computer (PDA), a mobile computer, a tablet computer, and the like.

The requestor device 102 includes transaction credentials (e.g., a payment account) of a requestor to enable the requestor device 102 to be a party to a payment transaction. If the requestor has a transaction account, the transaction account may also be included (i.e., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request. The customer uses the watch or similar wearable to make request regarding the transaction request by pressing a button on the watch or wearable.

The provider device 104 is associated with a provider who is also a party to the transaction request that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a travel co-ordinator or merchant) associated with the provider.

If the provider has a transaction account, the transaction account may also be included (i.e., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make request regarding the transaction request by pressing a button on the watch or wearable.

The acquirer server 106 is associated with an acquirer who may be an entity (e.g. a company or organization) which issues (e.g. establishes, manages, administers) a payment account (e.g. a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request to the transaction processing server 108.

The transaction processing server 108 is configured to process processes relating to a transaction account by, for example, forwarding data and information associated with the transaction to the other servers in the system 100 such as the product matching server 140. In an example, the transaction processing server 108 may, instead of the requestor device 102 or the provider device 104, transmit data relating to a product to the product matching server 140 for identifying a match with the product before a transaction (e.g. a payment transaction for requesting identification of the product) can be processed by the transaction processing server 108.

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g. a company or organization) which manages (e.g. establishes, administers) data relating to a plurality of products. In one arrangement, the data comprises one or more entries for each of the plurality of products, each entry representing an attribute describing the product. The data may also comprise an identifier such as a GTIN for each of the plurality of products. The data is used by the product matching server 140 for identifying a match with the product, and then mapping the product with the identifier of the identified match. The data may further comprise historical data relating to the product that may be used by the product matching server 140 for adapting the extracted one or more attributes relating to the product into a same format as that of the one or more entries in the reference database 150.

Advantageously, the system 100 enables efficient and accurate identification of a match with a product which can then be assigned a corresponding identifier such as a GTIN, so that each product being sold via a platform can be monitored, for example, in terms of sales performance during discounts, different seasons, months, specific holidays, and other similar scenarios, so that merchants can evaluate and adapt their marketing strategy. Such identification can also upscaled such that a plurality of products can be easily identified without spending large amounts of workhours to match via manually adding identifiers such as GTIN to each product.

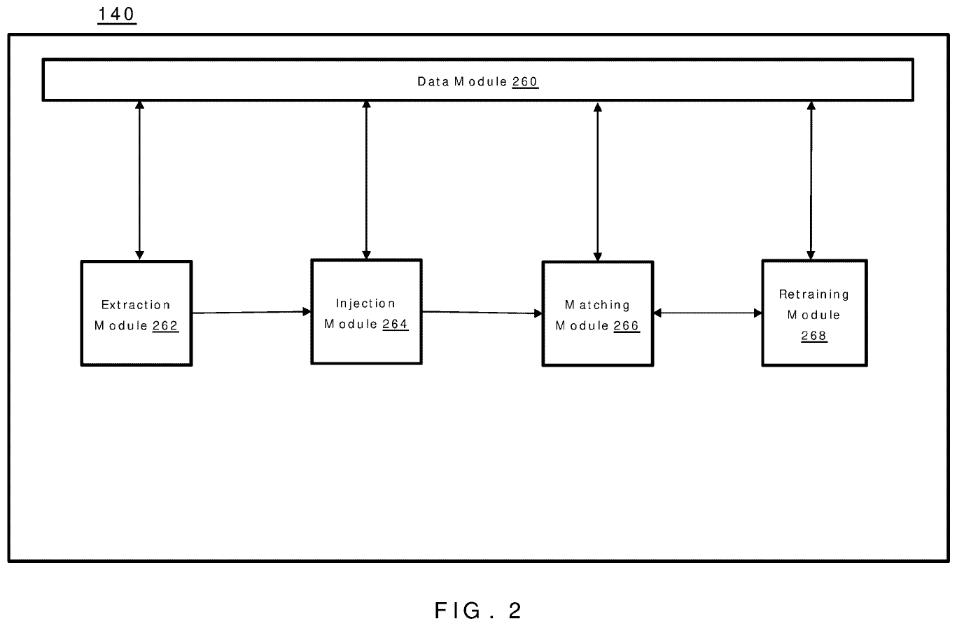

FIG. 2 illustrates a schematic diagram of the product matching server 140 according to various embodiments. The product matching server 140 may comprise a data module 260 configured to receive data and information from the requestor device 102, provider device 104, transaction processing server 108, a cloud and other sources of information to facilitate identification of a match with a product by the product matching server 140. For example, the data module 260 may be configured to receive data relating to a product from the requestor device 102, the provider device 104, transaction processing server 108 and/or other sources of information. The data module 260 may also be configured to receive historical data relating to the product from the transaction processing server 108, the reference image database 150, the internet, and/or other sources of information. The data module 260 may be further configured to send information relating to an identified match with the product such as an identifier, item name, brand name, and/or other similar information (e.g. information obtained based on the one or more entries associated with the identified match from reference database 150) obtained after a product matching process to the requestor device 102, the provider device 104, the transaction processing server 108, or other destinations where the information is required.

The product matching server 140 may comprise an extraction module 262 that is configured for extracting one or more attributes relating to a product from data indicated in a request for identifying the product, each of the one or more attributes describing the product. To address the challenges of unstructured and multimodal data that may be provided for identifying a match with the product, multimodal attribute extraction may be employed to advantageously enable the extraction module 262 to extract the one or more attributes relating to the product from image information together with commonly used textual information such item names, descriptions and other metadata.

The product matching server 140 may also comprise an injection module 264 that is configured for adapting the one or more extracted attributes based on historical data relating to the product into a same format as that of one or more entries in a database (e.g. the reference database 150), the database comprising one or more entries for each of a plurality of products. For example, the one or more attributes may be adapted into at least one of a unit of measurement, quantity, language or item name that is the same as that of one or more entries in the reference database 150. In one implementation, domain knowledge injection may be utilized to bridge the gap between the extracted attributes and the one or more entries in the reference database 150, wherein historical data relating to the product (such as domain knowledge, as well as labelled and unlabelled data relating to the product) are leveraged to enrich the extracted attributes. Domain knowledge may comprise product attribute synonyms in various languages, unit system, or other similar formats.

The product matching server 140 may also comprise a matching module 266 that is configured for identifying a match with the product from the plurality of products, the identification based on comparing the one or more attributes with each corresponding entry of the plurality of products in the reference database 150. Identifying the match with the product from the plurality of products may further comprise selecting one or more products from the plurality of products in the reference database 150 based on a rule-based comparison of at least one of the one or more attributes with each corresponding entry in the list, and identifying the match with the product from the selected one or more products, the identification based on comparing, by the processor, the one or more attributes with each corresponding entry of the selected one or more products.

In one implementation, the rule-based comparison may involve identifying one or more key attributes from the one or more attributes, and then selecting the one or more products from the plurality of products in the reference database 150 based on comparing the one or more key attributes with each corresponding entry in the reference database 150.

Comparing the one or more attributes with each corresponding entry of the selected one or more products may further comprise calculating a score for each of the one or more products based on the comparison, and identifying the match with the product when the score for the match is a top score among the calculated scores and greater than a threshold value. Selecting the one or more products from the plurality of products in the reference database 150 based on the rule-based comparison may further comprise identifying one or more key attributes from the one or more attributes, and selecting the one or more products from the plurality of products in the reference database 150 based on comparing the one or more key attributes with each corresponding entry in the list.

In one implementation, one or more matching candidates (e.g. the one or more products that are selected based on the comparison of the one or more attributes with each corresponding entry in the database 150) from the reference database 150 are shortlisted using a rule-based filtering approach based on the extracted attributes and injected domain knowledge of a given product. For each pair of the product and a matching candidate, a machine learning model is used for the matching module 266 to take pairwise heterogeneous attributes as input to calculate a matching score as output. Among all the pairs between the product and matching candidates, a match is identified based on a top score if it is greater than a given threshold, and a GTIN corresponding to the match is mapped or assigned into the product. Otherwise, the potential matching pairs are considered as confusing cases (e.g. pairs of which matching score is above the given threshold but not a top score) and will be sent to content operations of the platform for verification. Verification of the confusing cases by content operations may comprise various methods such as manual checking by a staff from content operations, and/or via algorithms, machine learning models and other similar methods.

The product matching server 140 may also comprise a retraining module 268 that is configured for retraining the matching module 266 based on a verification of whether each of the selected one or more products (excluding the identified match) having a score greater than the threshold value is also a match with the product. In one implementation, a regular cadence (e.g. daily, weekly or monthly depending on application) may be set to re-train the matching module 266 based on both historical and newly verified mappings from content operations of the platform (e.g. associations between a product and its identified or verified match in the reference database 150). This enables the matching module 266 to keep updated with latest feedback and learn updated empirical rules set by the content operations. Advantageously, the verified mappings can also help to enrich the original records in the reference database 150 by adding additional attributes such as typical images or local nicknames of products that are adapted into new entries in the reference database 150.

Each of the data module 260, extraction module 262, injection module 264, matching module 266 and retraining module 268 may further be in communication with a processing module (not shown) of the product matching server 140, for example for coordination of respective tasks and functions during the product matching process. The data module 260 may be further configured to communicate with and store data and information for each of the processing module, extraction module 262, injection module 264, matching module 266 and retraining module 268. Alternatively, all the tasks and functions required for identifying a match with a product may be performed by a single processor of the product matching server 140.

FIG. 3 depicts an overview of a process 300 for identifying a match with a product, according to various embodiments. At a first stage, a multimodal extraction is implemented (e.g. by the extraction module 262) for extracting one or more attributes relating to a product from data indicated in a request for identifying the product. The request for identifying the product may be a direct request that is sent from the requestor device 102 or provider device 104, or may be part of an on-boarding process for a product of a merchant onto the platform, so that the product can subsequently be viewed and bought by users of the platform. The data from which the attributes are extracted may be in various formats, such as textual format and image format.

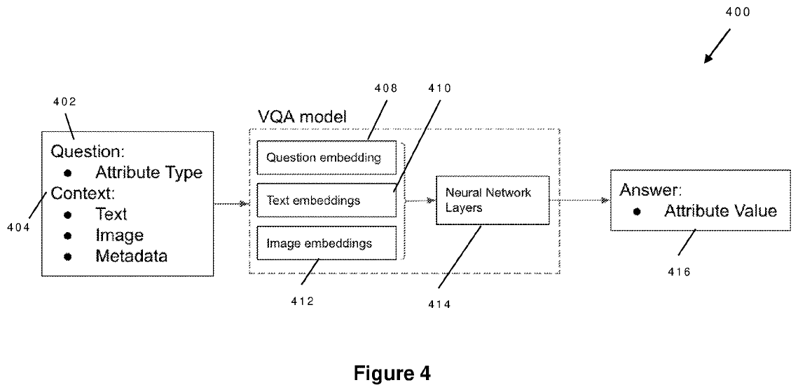

The data acquired from merchants for attribute extraction are usually incomplete, noisy and prone to errors. In addition, there are potentially thousands of different types of attributes (e.g., sugar level, flavour, color, quantity, volume, and other similar attributes) depending on the type of product. To address these challenges, a multimodal attribute extraction method based on a visual question and answering (VQA) paradigm may be utilized, such as shown in process 400 of FIG. 4. For example, given an image 604 and text 606 as shown in FIG. 6 as context, we can extract information for ‘volume’ by raising “what is volume?” as a question 402 to the VQA model 406 together with context 404, and the returned answer 416 will be the extracted attribute value of, for example, “320 MI”. There may be three types of embeddings upon which the VQA model 406 may base its attribute extraction, namely question embedding 408, text embeddings 410 and image embeddings 412. The question embedding 408 can be directly converted and derived from the string of attribute type of the question ‘what is volume?’, which in this case would be ‘volume’. For context of an item, text embeddings 410 may consist of item name, descriptions and texts that may be derived from image and text data relating to the product by utilizing optical character recognition (OCR) techniques. Image embeddings 412 may be generated from image patches derived from utilizing object and logo detection technology on image data relating to the product. These three embeddings may serve as input through a processing model such as a layered neural network model 414 to derive an answer 416 to the question 402.

The multi-modal attribute extraction process 302 using both image and text is different from existing methods which rely on Tf-idf or word embeddings approach on text, or which only focuses on the English language for attribute extraction. Multilingual trans-formers may be implemented in the multi-modal attribute extraction process 302 for interpreting text information, and develop and fuse multilingual modules may be developed and fused to interpret multilingual OCR from images. For example, the extraction module 262 may be fine-tuned to adapt to regional languages such as Malay, Thai and Vietnam-ese so that extracting attributes from information in such languages is possible.

The extracted attributes (an example being the answer 416 from VQA model 406) may need to be interpreted and normalized before comparing with the entries in the reference database 150, to ensure that information in both extracted attributes and corresponding entries in the reference database 150 are standardized into a same format. Thus, the extracted attributes go through a domain knowledge injection process 304 (e.g. implemented by the injection module 264) in which the one or more attributes are adapted based on historical data relating to the product into a same format as that of the one or more entries in the reference database 150. How each extracted attribute is adapted will depend on the type of attribute concerned. Some extracted attributes may undergo unit conversion based on domain knowledge rules to convert the value and unit of these attributes into a form that is the same as that of the corresponding entries in the reference database 150. For example, in a case where the reference database 150 comprises entries in milliliters for volume, in grams for weight and in centimetres for length, extracted attributes in fluid ounces may be converted to milliliters for volume, extracted attributes in pounds may be converted to grams for weight, and extracted attributes in inches may be converted to centimetre for length. Some extracted attributes may undergo quantity normalization, in which a set of rules are formulated for the domain knowledge injection process 304 to extract and calculate the quantity of items from common phrases used in product descriptions that may be present in the data relating to the product. For example, a rule may be set for the domain knowledge injection process 304 that the phrase “buy 1 get 1 free” will be equivalent to a quantity of 2, and thus a quantity attribute associated with this phrase is converted to 2 in the domain knowledge injection process 304. Further, some extracted attributes may undergo synonym normalization. For example, a synonym database of brand and product attribute synonyms may be maintained by content operations of the platform for various languages. The algorithm utilized by the domain knowledge injection process 304 can reference the synonym database to normalize the extracted brand names and attributes to align with corresponding entries in the reference database 150. Incorporating and injecting historical data relating to the product such as domain knowledge to bridge the gap between extracted attributes and entries in the reference database 150 advantageously enables the system to accurately interpret and com-pare the extracted attributes across different sources or regions.

After the domain knowledge injection process 304 is completed, the extracted and normalized attributes undergo an auto-adaptive matching process 306 (e.g. implemented by the matching module 368), in which a match with the product is identified from the plurality of products in the reference database 150, the identification based on comparing the one or more attributes with each corresponding entry of the plurality of products. The identification may be based on a two-stage hybrid framework to advantageously reduce computational complexity. At a first stage, a shortlist of candidates (e.g. potential matches with the concerned product) may be selected from the plurality of products in the reference database 150. For example, one or more products from the plurality of products in the reference database 150 may be selected based on a rule-based comparison of at least one of the one or more attributes with each corresponding entry in the reference database 150. The rule-based comparison may be implemented such that one or more key attributes may be identified from the one or more attributes, and then the one or more products from the plurality of products in the reference database 150 are selected based on comparing the one or more key attributes with each corresponding entry in the reference database 150. The key attributes to be identified from the one or more attributes may be set by content operations of the concerned platform or determined by the matching module 368 based on, for example, historical data from past comparisons. At a second stage, a computational expensive neural network model may be implemented to further process the shortlisted candidates with high precision to identify a match with the concerned product through comparing the one or more extracted attributes with each corresponding entry of the shortlisted candidates. A score for each of the shortlisted candidates may be calculated based on the comparison, and a match with the product may be identified when the score for the match is a top score among the calculated scores and greater than a threshold value. The threshold value may be set by content operations of the concerned platform or determined by the matching module 368 based on, for example, historical data from past comparisons.

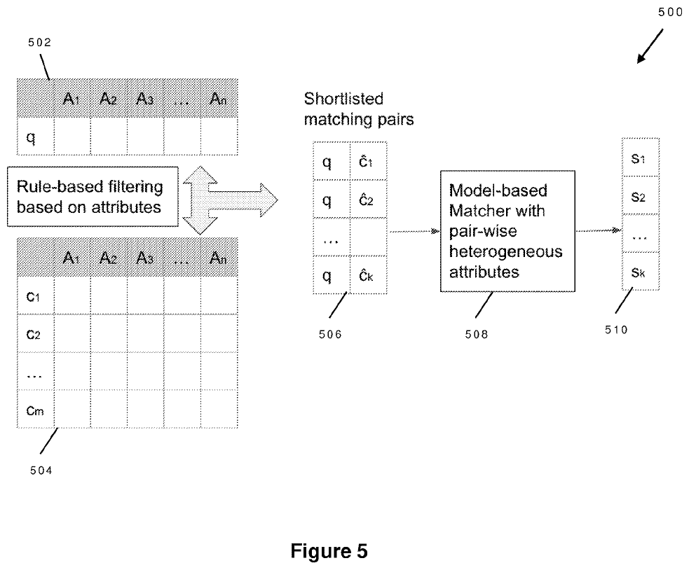

An example implementation of the two-stage hybrid framework is shown in illustration 500 of FIG. 5. Referring to table 502, the concerned product for which a match is to be identified may be denoted as q, and extracted attributes of the concerned product after knowledge injection may be denoted as A_{1,2, . . . , n}, where n is the number of extracted attributes. Similarly, referring to table 504, the plurality of products on the reference database 150 may be denoted as c_{1,2, . . . , m} with their corresponding attributes A_{1,2, . . . , n}, where m is the row number of the table 504. A rule-based matching will help to filter out the majority of unrelated candidates in the reference database 150 based on the matching of key attributes such as brand, size, quantity and other attributes between the concerned product q and the plurality of products c_{1,2, . . . , m}. As a result, we have a shortlisted k pairs (q, ĉ_{1,2, . . . , k}) of potential matches as shown in table 506. This shortlisting procedure advantageously helps to reduce the computation load for the next stage. For each pair, both the product q and plurality of shortlisted candidates ĉ_{1,2, . . . , k} together with their attributes will be fed into a neural network model 508 based on a multi-modal transformer to calculate their final matching score (s_{1,2, . . . , k}) as shown in table 510. Based on the matching scores, the matching module 368 may identify a match from the shortlisted candidates c_{1,2, . . . , k} with the product q when the score for the match is a top score among the calculated scores and greater than a threshold value, for example as shown in process 308 of FIG. 3). The matching module 368 may also proceed to map the product q with an identifier such as a GTIN of the identified match.

For the remaining shortlisted candidates which, for example, have a score greater than the threshold value but are not the top score, these potential pairs may be forwarded to content operations of the concerned platform for further verification, for example as shown in process 310 of FIG. 3. In process 310, each of the potential pairs (e.g. the selected one or more products excluding the identified match having a score greater than the threshold value) is verified by content operations whether these are also matches with the product. Verification of the potential pairs by content operations may comprise various methods such as manual checking by a staff from content operations, and/or via algorithms, machine learning models and other similar methods. Based on the verification, the matching module 266 is retrained. This may be termed as an auto-adaptive data flywheel, which advantageously enables the matching module 266 to automatically adapt to changes in, for example, the reference database 150 and based on feedback from the content operations of the concerned platform. This may be performed on a regular basis (e.g. daily, weekly or monthly depending on application) and enables enrichment of the reference database 150 with additional information from content operations' verified matching pairs while re-training the matching module 266. During the matching model re-training, a hard negative pair mining scheme may be utilized to sample those uncertain or wrongly identified results based on the content operations' feedback, and thus the matching module 266 can learn such feedback during the retraining, and improve its accuracy in future identifications.

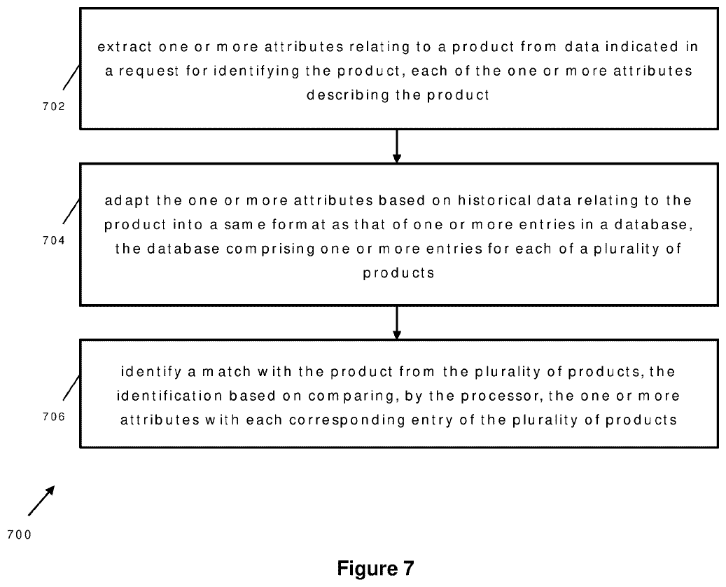

FIG. 7 illustrates an example flow diagram of a method for identifying a match with a product according to various embodiments. In a step 702, one or more attributes relating to a product are extracted from data indicated in a request for identifying the product, each of the one or more attributes describing the product. In a step 704, the one or more attributes are adapted based on historical data relating to the product into a same format as that of one or more entries in a database, the database comprising one or more entries for each of a plurality of products. In a step 706, a match with the product is identified from the plurality of products, the identification based on comparing, by the processor, the one or more attributes with each corresponding entry of the plurality of products.

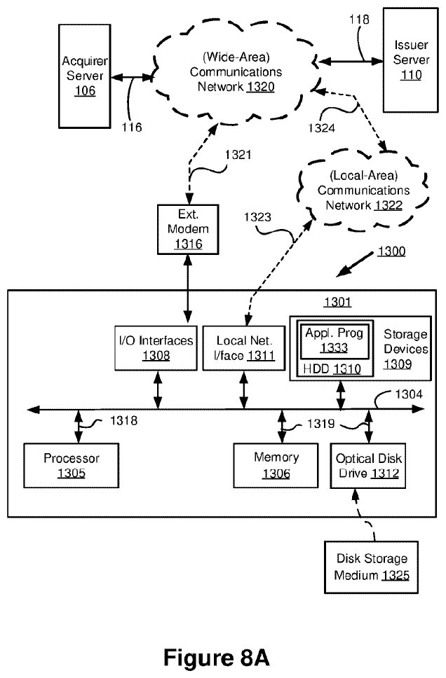

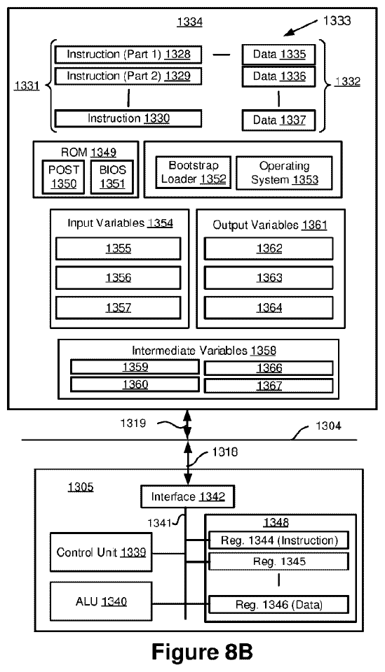

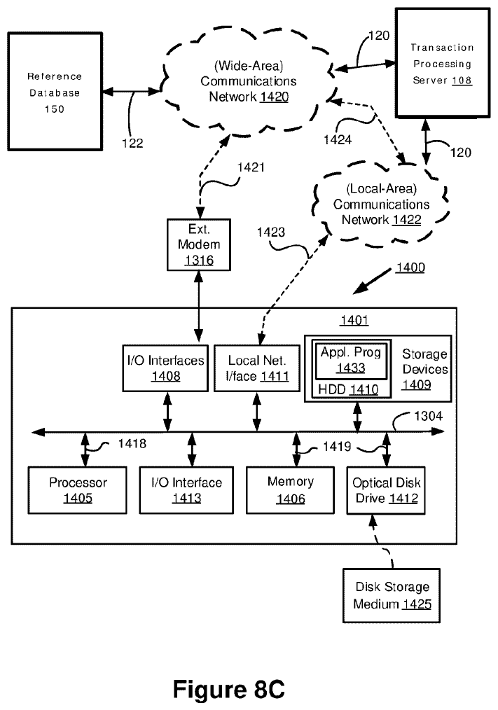

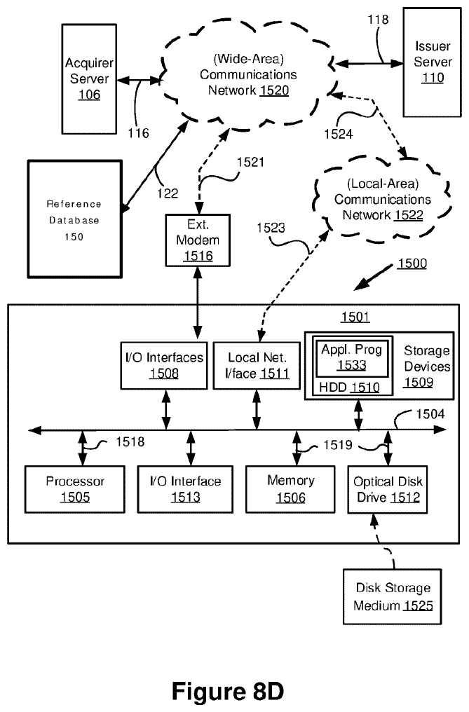

FIGS. 8A and 8B form a schematic block diagram of a general purpose computer system upon which the transaction processing server of FIG. 1 can be practiced.

As seen in FIG. 8A, the computer system 1300 includes a computer module 1301. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an interface 1308 for the external modem 1316. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 8A, the local communications network 1322 may also couple to the wide network 1320 via a connection 1324, which would typically include a so-called “firewall” device or device of similar functionality. The local network interface 1311 may comprise an Ethernet circuit card, a Bluetooth® wireless arrangement or an IEEE 802.11 wireless arrangement; however, numerous other types of interfaces may be practiced for the interface 1311.

The I/O interfaces 1308 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks, USB-RAM, portable, external hard drives, and floppy disks, for example, may be used as appropriate sources of data to the system 1300.

The components 1305 to 1312 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple or like computer systems.

The steps of the method 700 in FIG. 7 facilitated by the transaction processing server 108 may be implemented using the computer system 1300. For example, the steps of the method 700 may be implemented as one or more software application programs 1333 executable within the computer system 1300. In particular, the steps of the method 700 as facilitated by the transaction processing server 108 are effected by instructions 1331 (see FIG. 6B) in the software 1333 that are carried out within the computer system 1300. The software instructions 1331 may be formed as one or more code modules, each for performing one or more particular tasks. The software may also be divided into two separate parts, in which a first part and the corresponding code modules facilitates the steps of the method 700 and a second part and the corresponding code modules manage a user interface between the first part and the user.

The software may be stored in a computer readable medium, including the storage devices described below, for example. The software is loaded into the computer system 1300 from the computer readable medium, and then executed by the computer system 1300. A computer readable medium having such software or computer program recorded on the computer readable medium is a computer program product. The use of the computer program product in the computer system 1300 preferably effects an advantageous apparatus for a transaction processing server 108.

The software 1333 is typically stored in the HDD 1310 or the memory 1306. The software is loaded into the computer system 1300 from a computer readable medium, and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 preferably effects an apparatus for a transaction processing server 108.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, optical disk, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon a display. Through manipulation of typically a keyboard and a mouse, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

FIG. 8B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 8A.

When the computer module 1301 is initially powered up, a power-on self-test (POST) program 1350 executes. The POST program 1350 is typically stored in a ROM 1349 of the semiconductor memory 1306 of FIG. 8A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 8A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 8A must be used properly so that each process can run effectively. Accordingly, the aggregated memory 1334 is not intended to illustrate how particular segments of memory are allocated (unless otherwise stated), but rather to provide a general view of the memory ac-cessible by the computer system 1300 and how such is used.

As shown in FIG. 8B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 8A. The execution of a set of the instructions may in some cases result in output of data. Execution may also involve storing data or variables to the memory 1334.

The disclosed transaction processing server 108 arrangements use input variables 1354, which are stored in the memory 1334 in corresponding memory locations 1355, 1356, 1357. The transaction processing server 108 arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 8B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:
a fetch operation, which fetches or reads an instruction 1331 from a memory location 1328, 1329, 1330;
a decode operation in which the control unit 1339 determines which instruction has been fetched; and
an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step or sub-process in the processes as performed by the transaction processing server 108, is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

It is to be understood that the structural context of the computer system 1300 (i.e., the transaction processing server 108) is presented merely by way of example. Therefore, in some arrangements, one or more features of the server 1300 may be omitted. Also, in some arrangements, one or more features of the server 1300 may be combined together. Additionally, in some arrangements, one or more features of the server 1300 may be split into one or more component parts.

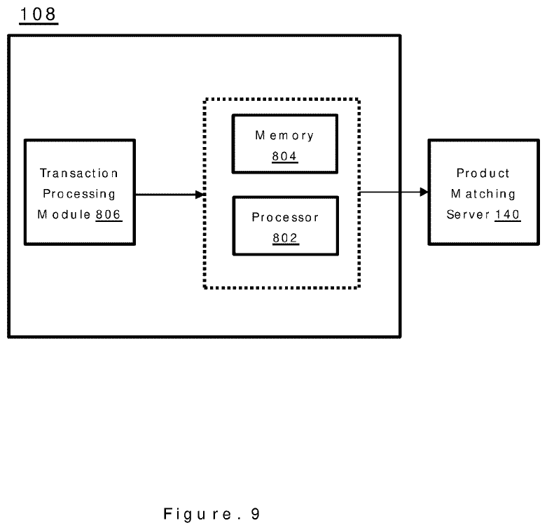

FIG. 9 shows an alternative implementation of the transaction processing server 108 (i.e., the computer system 1300). In the alternative implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 700. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, travel request message, a request for identifying a match with a product, a request for on-boarding a product with the concerned platform, or other similar messages. Further, the transaction processing module 806 may provide data and information relating to a product to the product matching server 140 for identifying a match with the product, for example before a transaction (e.g. a payment transaction for requesting identification of the product) can be processed by the transaction processing server 108, or before a product can be on-boarded to the platform.

FIG. 8C depict a general-purpose computer system 1400, upon which the product matching server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8C, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1404 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 700, where performed by the product matching server 140 may be implemented using the computer system 1400. The processes may be implemented as one or more software application programs 1433 executable within the computer system 1400. In particular, the sub-processes 400, 500, and 600 are effected by instructions (see corresponding component 1331 in FIG. 8B) in the software 1433 that are carried out within the computer system 1400. The software instructions may be formed as one or more code modules, each for performing one or more particular tasks. The software may also be divided into two separate parts, in which a first part and the corresponding code modules performs the methods and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a product matching server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a product matching server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the product matching server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

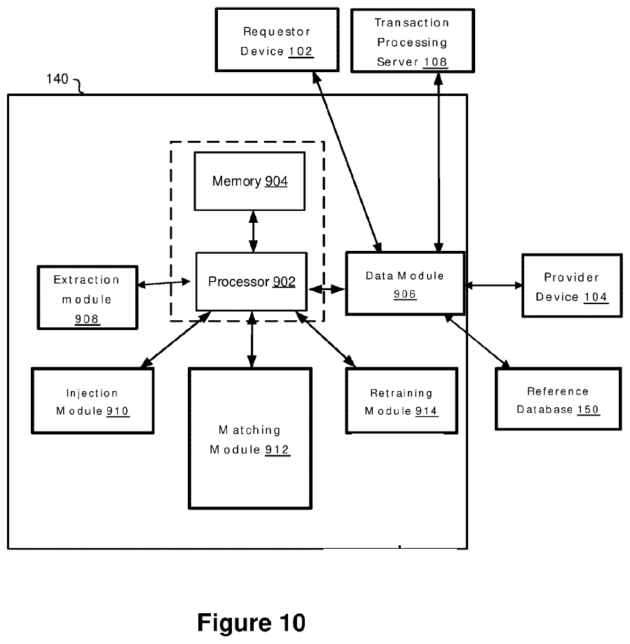

FIG. 10 shows an alternative implementation of the product matching server 140 (i.e., the computer system 1400). In the alternative implementation, product matching server 140 may be generally described as a physical device comprising at least one processor 902 and at least one memory 904 including computer program codes. The at least one memory 904 and the computer program codes are configured to, with the at least one processor 902, cause the product matching server 140 to perform the operations described in the method 700. The product matching server 140 may also include a data module 906, an extraction module 908, an injection module 910, a matching module 912 and a retraining module 914. The memory 904 stores computer program code that the processor 902 compiles to have each of the modules 906 to 914 performs their respective functions.

With reference to FIGS. 1 to 7, the extraction module 908 performs the function of extracting one or more attributes relating to a product from data indicated in a request for identifying the product, each of the one or more attributes describing the product.

With reference to FIGS. 1 to 7, the injection module 910 performs the function of adapting the one or more attributes based on historical data relating to the product into a same format as that of one or more entries in a database (e.g. the reference database 150), the database comprising one or more entries for each of a plurality of products. The the one or more attributes may be adapted into at least one of a unit of measurement, quantity, language or item name that is the same as that of one or more entries in the database.

With reference to FIGS. 1 to 7, the matching module 912 performs the function of identifying a match with the product from the plurality of products, the identification based on comparing the one or more attributes with each corresponding entry of the plurality of products. Identifying the match with the product from the plurality of products may further comprise selecting one or more products from the plurality of products in the database based on a rule-based comparison of at least one of the one or more attributes with each corresponding entry in the database; and identifying the match with the product from the selected one or more products, the identification based on comparing the one or more attributes with each corresponding entry of the selected one or more products. Comparing the one or more attributes with each corresponding entry of the selected one or more products may further comprise calculating a score for each of the selected one or more products based on the comparison; and identifying the match with the product when the score for the match is a top score among the calculated scores and greater than a threshold value. Further, selecting the one or more products from the plurality of products in the database based on the rule-based comparison may further comprise identifying one or more key attributes from the one or more attributes; and selecting the one or more products from the plurality of products in the database based on comparing the one or more key attributes with each corresponding entry in the database. The matching module 912 may also perform the function of mapping the product with an identifier of the identified match.

With reference to FIGS. 1 to 7, the retraining module 914 performs the function of retraining the matching module 912 based on a verification whether each of the selected one or more products excluding the identified match having a score greater than the threshold value is also a match with the product.

With reference to FIGS. 1 to 7, the data module 906 performs the functions of receiving data and information from the requestor device 102, provider device 104, transaction processing server 108, reference database 150, a cloud, the internet, and other sources of information to facilitate the method 700. For example, the data module 906 may be configured to receive data relating to a product from the requestor device 102, the provider device 104, transaction processing server 108 and/or other sources of information. The data module 260 may also be configured to receive historical data relating to the product from the transaction processing server 108, the reference image database 150, the internet, and/or other sources of information. The data module 260 may be further configured to send information relating to an identified match with the product such as an identifier, item name, brand name, and/or other similar information (e.g. information obtained based on the one or more entries associated with the identified match from reference database 150) obtained after a product matching process to the requestor device 102, the provider device 104, the transaction processing server 108, or other destinations where the information is required.

FIG. 8D depicts a general-purpose computer system 1500, upon which a combined transaction processing server 108 and product matching server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 700 performed by the product matching server 140 and facilitated by the transaction processing server 108 may be implemented using the computer system 1500. For example, the steps of the method 700 as performed by the product matching server 140 may be implemented as one or more software application programs 1533 executable within the computer system 1500. In particular, the steps of the method 700 are effected by instructions (see corresponding component 1331 in FIG. 8B) in the software 1533 that are carried out within the computer system 1500. The software instructions may be formed as one or more code modules, each for performing one or more particular tasks. The software may also be divided into two separate parts, in which a first part and the corresponding code modules performs the steps of the method 700 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and product matching server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and product matching server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., combined transaction processing and product matching server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

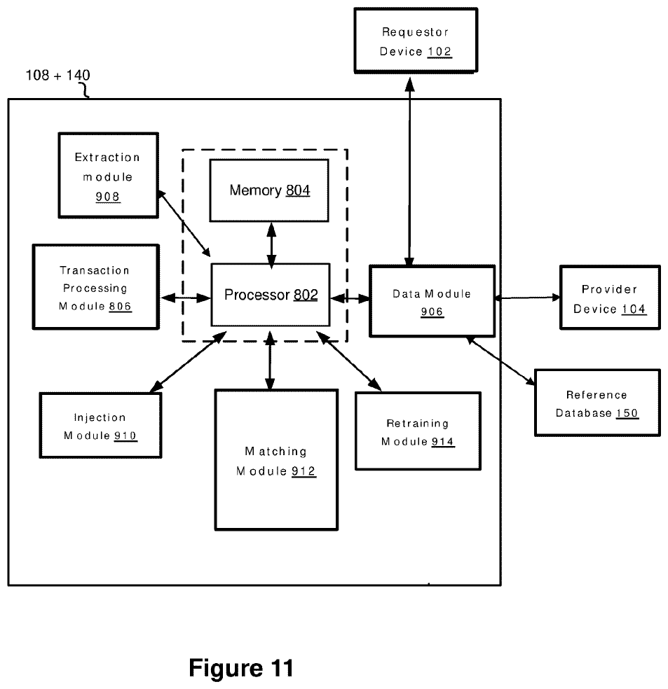

FIG. 11 shows an alternative implementation of combined transaction processing and product matching server (i.e., the computer system 1500). In the alternative implementation, the combined transaction processing and product matching server may be generally described as a physical device comprising at least one processor 1002 and at least one memory 904 including computer program codes. The at least one memory 1004 and the computer program codes are configured to, with the at least one processor 1002, cause the combined transaction processing and product matching server to perform the operations described in the steps of the method 700. The combined transaction processing and product matching server may also include a transaction processing module 806, a data module 906, an extraction module 908, an injection module 910, a matching module 912 and a retraining module 914. The memory 1004 stores computer program code that the processor 1002 compiles to have each of the modules 806 to 912 performs their respective functions. The transaction processing module 806 performs the same functions as described for the same transaction processing module in FIG. 9. The data module 906, extraction module 908, injection module 910, matching module 912 and re-training module 914 perform the same functions as described for the same corresponding modules in FIG. 10.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

What is claimed is:

1. A method for identifying a match with a product, comprising
extracting, by a processor, one or more attributes relating to a product from data indicated in a request for identifying the product, each of the one or more attributes describing the product, wherein the data comprises an image of the product and extracting the one or more attributes comprises identifying the one or more attributes from the image based on a visual question and answering (VQA) paradigm;
adapting, by the processor, the one or more attributes based on historical data relating to the product into a same format as that of one or more entries in a database, the database comprising one or more entries for each of a plurality of products;
identifying a match with the product from the plurality of products, the identification based on comparing, by the processor, the one or more attributes with each corresponding entry of the plurality of products;
selecting one or more products from the plurality of products in the database based on a rule-based comparison of at least one of the one or more attributes with each corresponding entry in the database;
identifying the match with the product from the selected one or more products, the identification based on comparing, by the processor, the one or more attributes with each corresponding entry of the selected one or more products;
calculating a score for each of the selected one or more products based on the comparison;
identifying the match with the product when the score for the match is a highest score of the calculated scores and greater than a threshold value;
verifying whether each of the selected one or more products excluding the identified match having a score greater than the threshold value is also a match with the product; and
retraining the processor based on the verification.

2. The method of claim 1, wherein selecting the one or more products from the plurality of products in the database based on the rule-based comparison further comprises:
identifying one or more key attributes from the one or more attributes; and
selecting the one or more products from the plurality of products in the database based on comparing the one or more key attributes with each corresponding entry in the database.

3. The method of claim 1, further comprising adapting, by the processor, the one or more attributes into at least one of a unit of measurement, quantity, language or item name that is the same as that of one or more entries in the database.

4. The method of claim 1, wherein the database further indicates an identifier for each of the plurality of products, the method further comprising mapping the product with the identifier of the identified match.

5. A system for identifying a match with a product, comprising:
at least one processor; and
at least one memory including computer program code;
the at least one memory and the computer program code configured to, with the at least one processor, cause the system at least to:
extract, by a processor, one or more attributes relating to a product from data indicated in a request for identifying the product, each of the one or more attributes describing the product, wherein the data comprises an image of the product and extracting the one or more attributes comprises identifying the one or more attributes from the image based on a visual question and answering (VQA) paradigm;
adapt, by the processor, the one or more attributes based on historical data relating to the product into a same format as that of one or more entries in a database, the database comprising one or more entries for each of a plurality of products;
identify a match with the product from the plurality of products, the identification based on comparing, by the processor, the one or more attributes with each corresponding entry of the plurality of products;
select one or more products from the plurality of products in the database based on a rule-based comparison of at least one of the one or more attributes with each corresponding entry in the database;
identify the match with the product from the selected one or more products, the identification based on comparing, by the processor, the one or more attributes with each corresponding entry of the selected one or more products;
calculate a score for each of the selected one or more products based on the comparison;
identify the match with the product when the score for the match is a highest score of the calculated scores and greater than a threshold value;
verify whether each of the selected one or more products excluding the identified match having a score greater than the threshold value is also a match with the product; and
retrain the processor based on the verification.

6. The system of claim 5, wherein selecting the one or more products from the plurality of products in the database based on a rule-based comparison further comprises:
identifying one or more key attributes from the one or more attributes; and
selecting the one or more products from the plurality of products in the database based on comparing the one or more key attributes with each corresponding entry in the database.

7. The system of claim 5, further configured to:
adapt, by the processor, the one or more attributes into at least one of a unit of measurement, quantity, language or item name that is the same as that of one or more entries in the database.

8. The system of claim 5, wherein the database further indicates an identifier for each of the plurality of products, and wherein the system is further configured to map the product with the identifier of the identified match.
